(19) United States
(12) Patent Application Publication
(10) Pub. No.: US 2007/0274011 A1
(43) Pub. Date: Nov. 29, 2007

(54) Magnetoresistive effect element and a thin film magnetic head

(75) Inventors: Naoki Ohta, Chuo-ku (JP); Noriaki Kasahara, Chuo-ku (JP)

Correspondence Address: FROMMER LAWRENCE & HAUG, 745 FIFTH AVENUE- 10TH FL., NEW YORK, NY, 10151, US

(73) Assignee: TDK Corporation, Chuo-ku (JP)

(21) Appl. No.: 11/783,043

(22) Filed: Apr. 5, 2007

(30) Foreign Application Priority Data
May 24, 2006 (JP) 143760/2006

(51) Int. Cl. G11B 5/127

(52) U.S. Cl. 360/328

(57) ABSTRACT

The present invention relates to a magnetoresistive (MR) effect element which can effectively reduce a leakage of magnetic flux from a magnetic domain control layer, and a thin film magnetic head which has the MR effect element. The MR effect element has a pair of magnetic domain control layer, each of which magnetically connects a MR effect multilayered structure, and an additional york layer. Each end of the additional york layer is respectively connected with a magnetic domain control layer, and the additional york layer leads magnetic flux from one magnetic domain control layer to another magnetic domain control layer.

### PRIORITY CLAIM

This application claims priority from Japanese patent application No. 2006-143760 filed on May 24, 2006, which is incorporated herein by reference.

### BACKGROUND OF THE INVENTION

1. Field of the Invention

The present invention relates to a magnetoresistive (MR) effect element which has a magnetoresistive effect multilayered structure, and a thin film magnetic head which has the MR effect element.

2. Description of the Related Art

Along with the development of high capacity and small hard disc drive (HDD), thin film magnetic heads with high sensitivity and output are required. For this requirement, characteristic of a giant magnetoresistive (GMR) head, which has a GMR effect reading head element, has been improved. On the other hand, a tunnel magnetoresistive (TMR) head, which has a TMR effect reading head element, has been actively developed. The ratio of resistance change of TMR heads is expected to be more than double compared to the one of GMR heads.

A TMR head structure is different from a general GMR head structure, because a direction of sense current is different. A head structure, which uses sense current in a direction parallel to a lamination plane or film surface like general GMR heads, is called Current in Plane (CIP) structure, and a head structure, which uses sense current in a direction perpendicular to a lamination plane like TMR heads, is called Current Perpendicular to Plane (CPP) structure. Recently, GMR heads with CPP structure has been developed.

Normally, a magnetic domain control layer, which aligns magnetic domain of a free layer in a MR effect multilayered structure and eliminates a magnetic wall, is provided for both GMR and TMR heads. In many cases, the magnetic domain control layer has for example hard magnetic layers or hard bias layers, which are placed both ends of the MR effect multilayered structure.

However, in both GMR and TMR heads according to the prior art, there is a problem that the leakage of magnetic flux from the magnetic domain control layer is big, therefore magnetic field which is applied to the free layer for aligning become small.

To solve the above-mentioned problem, JP patent publication 2002-123912A discloses a MR effect element for GMR head with CIP structure, which has soft magnetic layers joined to the hard magnetic layer. According to JP patent publication 2002-123912A, each hard magnetic layer is joined to the same MR effect multilayered structure at one end, and joined to a soft magnetic layer at another end respectively. Each soft magnetic layer has an overhang portion at the opposite side of the junction with the hard magnetic layer, and overhang portions of each soft magnetic layer are placed closely.

### SUMMARY OF THE INVENTION

Since the MR effect element described in JP patent publication 2002-123912A has a gap between overhang portions, magnetic circuit by the soft magnetic material breaks at this portion, and magnetic flux is diffused. Furthermore, shield gap layers, which are provided between a lower/upper shield layer and the MR effect multilayered structure, are extremely thin for recent MR effect elements. Here, the lower and the upper shield layer are provided for shielding the MR effect multilayered structure. Therefore, most magnetic flux from the magnetic domain control layer enters into the lower and the upper shield layer instead of the magnetic circuit which has a gap. As the result, magnetic flux become unstable at the point located immediately above the junction point of the magnetic domain control layer and the free layer, and it causes the magnetic disturbance in the free layer.

The invention has been made in view of the above-mentioned problem, and it is therefore an object of the present invention to provide a MR effect element and a thin film magnetic head, which can effectively prevent leakage of magnetic flux into the shield layer from the magnetic domain control layer.

It is another object of the present invention to provide a MR effect element and a thin film magnetic head, which prevent eddy magnetic field in the shield layer near the free layer caused by the magnetic flux applied from the magnetic domain control layer.

According to the present invention, a magnetoresistive effect element includes an upper shield layer, a lower shield layer, a magnetoresistive effect multilayered structure which has a magnetization fixed layer and a magnetization free layer, a first magnetic domain control layer, a second magnetic domain control layer and an additional york layer which is layered independently. The magnetization fixed layer mainly includes a pinned layer and a pinning layer, and the magnetization free layer includes a free layer. The magnetoresistive effect multilayered structure is layered between the upper shield layer and the lower shield layer. One end of the first magnetic domain control layer is magnetically coupled or connected with one end of the magnetization free layer, and one end of the second magnetic domain control layer is magnetically coupled or connected with another end of the magnetization free layer. The first and the second magnetic domain control layers generate a magnetic flux for controlling magnetic domain of the magnetization free layer. One end of the additional york layer is magnetically coupled or connected with another end of the first magnetic domain control layer, and another end of the additional york layer is magnetically coupled or connected with another end of the second magnetic domain control layer. The additional york layer leads magnetic flux from another end of the first magnetic domain control layer to another end of the second magnetic domain control layer magnetically and continuously.

The first and the second magnetic domain control layers, which generate a magnetic flux for controlling magnetic domain of the free layer, connect with the additional york layer. Since the additional york layer leads magnetic flux from the first magnetic domain control layer to the second magnetic domain control layer magnetically and continuously, most magnetic flux from the magnetic domain control layer enters into the additional york layer, and circulates. Therefore only a little magnetic flux enters the lower and the upper shield layers. Furthermore, magnetic flux, which enters into the lower shield layer and the upper shield layer, flows constant at the point located immediately above the free layer, and eddy magnetic field is not generated in the shield layer near the free layer. As the result, the magnetic flux from the magnetic domain control layer does not cause magnetic disturbance of the free layer.

Favorably, each magnetic domain control layer is made of a hard magnetic layer which is extended to a direction parallel to a longitudinal direction of the magnetization free layer.

Favorably, a coupling end of each hard magnetic layer with the additional york layer is formed in such a way that it bumps into a coupling end of the additional york layer.

Favorably, each magnetic domain control layer includes an antiferromagnetic layer, and a soft ferromagnetic layer, which is exchange-coupled with the antiferromagnetic layer.

Favorably, the additional york layer is formed in a plane which is parallel to a plane that the pair of magnetic domain control layer is formed.

Favorably, the additional york layer includes two arm sections and a parallel section. Each arm section is extended away from a magnetic detection surface, the parallel section is extended parallel to the magnetic detection surface, and each end of the parallel section is connected with an arm section respectively.

Advantageously, the additional york layer is formed in a region that the upper shield layer and the lower shield layer exit.

Advantageously, the additional york layer is also formed outside a region that the upper shield layer and the lower shield layer exit.

Advantageously, the additional york layer is made of a soft magnetic material, which magnetic permeability is higher than the one of a magnetic material for the upper shield layer and the lower shield layer.

Advantageously, the magnetoresistive effect multilayered structure uses sense current perpendicular to a lamination plane.

According to the present invention, a thin film magnetic head includes the magnetoresistive effect element described above.

According to the invention, most magnetic flux from the magnetic domain control layer enters into the additional york layer, and a little magnetic flux enters into the lower and the upper shield layers. Furthermore, magnetic flux, which enters into the lower shield layer and the upper shield layer, flows constant at the point located immediately above the free layer, therefore eddy magnetic field is not generated in the shield layer near the free layer. As the result, the magnetic flux from the hard bias layer does not cause the magnetic disturbance of the free layer.

### BRIEF DESCRIPTION OF THE DRAWINGS

FIG. 1 shows a schematic cross section view of a thin film magnetic head as one embodiment of the invention;

FIG. 2 shows a cross section view of a MR effect element part of the thin film magnetic head shown in FIG. 1;

FIG. 3 shows a plane view of a MR effect element part of the thin film magnetic head shown in FIG. 1;

FIG. 4a1 to 4f2 show a cross section and plane view for explaining the part of manufacturing process of a TMR effect reading head element;

FIG. 5 shows one embodiment of the dimension for an additional york layer;

FIG. 6 shows a simulation result of magnetic flux from the hard bias layer without the additional york layer;

FIG. 7 shows a simulation result of magnetic flux from the hard bias layer with the additional york layer; and

FIG. 8a to 8c show various embodiments of joining of the hard bias layer and the additional york layer.

### DETAILED DESCRIPTION OF THE INVENTION

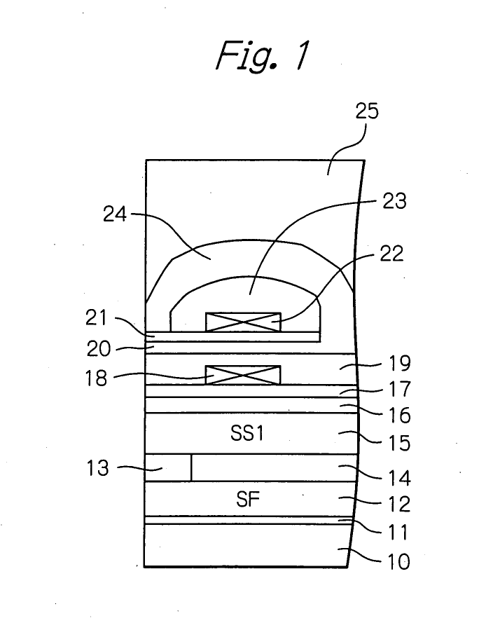

FIG. 1 shows a schematic cross section view of a thin film magnetic head as one embodiment of the invention. Cross section surface of FIG. 1 is a surface, which is perpendicular to both an air bearing surface (ABS) and a track width direction. The track width direction is the direction, which is parallel to a longitudinal direction of a free layer.

In FIG. 1, reference numeral 10 represents a substrate or wafer, reference numeral 11 represents a under insulation layer laminated on the substrate 10, reference numeral 12 represents a lower shield layer (SF), which is also used as a lower electrode layer, laminated on the under insulation layer 11, reference numeral 13 represents a MR effect multilayered structure formed on the lower shield layer 12, reference numeral 14 represents a shield insulation layer, reference numeral 15 represents an upper shield layer (SS1), which is also used as an upper electrode layer, and reference numeral 16 represents a nonmagnetic intermediate layer that separates a MR effect reading head element part from a inductive writing head element part. For example, the MR effect multilayered structure 13 may be a TMR effect multilayered structure or GMR effect multilayered structure with CPP structure.

On the nonmagnetic intermediate layer 16, an insulation layer 17, a bucking coil layer 18, a bucking coil insulation layer 19, a main magnetic pole layer 20, an insulating gap layer 21, a writing coil layer 22, a writing coil insulation layer 23 and an inductive writing head element are provided. The inductive writing head element has an auxiliary magnetic pole layer 24, which configures a return york. On the inductive writing head element, a protection layer 25 is formed.

In this embodiment, the inductive writing head element for perpendicular magnetic recording is used, however it is very clear that an inductive writing head element for longitudinal magnetic recording can be used. Furthermore, it is possible to use several types of perpendicular magnetic recording structure other than shown in FIG. 1 for the inductive writing head element.

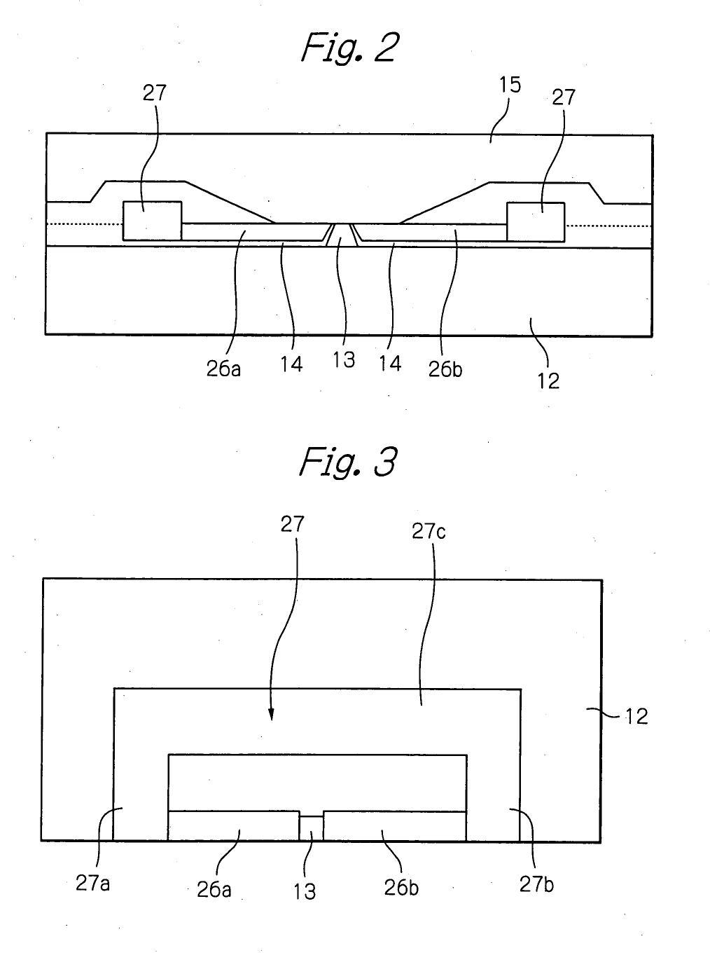

FIG. 2 shows a cross section view of a MR effect reading head element part of the thin film magnetic head shown in FIG. 1, and FIG. 3 shows a plane view of the MR effect reading head element part. Here, FIG. 2 shows a cross section, which is parallel to ABS, and FIG. 3 shows a plane, which is perpendicular to ABS and parallel to the track width direction.

The MR effect element according to the embodiment is a TMR effect reading head element or a GMR effect reading head element with CPP structure. As shown in FIG. 2 and FIG. 3, a bottom side of the MR effect multilayered structure 13 is electrically connected to the lower shield layer 12, which is used as a lower electrode layer, and a top side of the MR effect multilayered structure 13 is electrically connected to the upper shield layer 15, which is used as an upper electrode layer.

In case of the TMR effect reading head element, the MR effect multilayered structure 13 includes a magnetization free layer, a barrier layer and a magnetization fixed layer, although they are not shown in figures. The barrier layer is made of nonmagnetic insulator and laminated between the magnetization free layer and the magnetization fixed layer. The magnetization free layer mainly includes a free layer made of ferromagnetic material, and the magnetization fixed layer mainly includes a pinned layer made of ferromagnetic material and a pinning layer made of antiferromagnetic material.

In case of the GMR effect reading head element with CPP structure, the MR effect multilayered structure 13 includes a magnetization free layer, a space layer and a magnetization fixed layer, although they are not shown in figures. The space layer is made of nonmagnetic conductor and laminated between the magnetization free layer and the magnetization fixed layer. The magnetization free layer mainly includes a free layer made of ferromagnetic material, and the magnetization fixed layer mainly includes a pinned layer made of ferromagnetic material and a pinning layer made of antiferromagnetic material.

One end of the MR effect multilayered structure 13 is magnetically connected or couple with one end of a magnetic domain control layer 26a, and another end of the MR effect multilayered structure 13 is magnetically connected or couple with one end of a magnetic domain control layer 26b. Both magnetic domain control layer 26a and 26b are isolated from the lower shield layer 12 and the upper shield layer 15 by the shield insulation layer 14.

According to the embodiment, both magnetic domain control layer 26a and 26b are formed by a hard magnetic layer or a hard bias layer, which is extended to the track width direction, that is a direction parallel to longitudinal direction of the free layer.

Another end of a magnetic domain control layer 26a is magnetically coupled or connected with one end of an additional york layer 27, and another end of a magnetic domain control layer 26b is magnetically coupled or connected with another end of the additional york layer 27. Here the additional york layer 27 is independently formed. In this case, contact point of magnetic domain control layer 26a/26b to the additional york layer 27 is advantageously formed such that it bumps into the contact end of the additional york layer 27, because it leads the magnetic flux from the hard magnetic layer to the additional york layer 27 smoothly.

The additional york layer 27 connects the magnetic domain control layer 26a with the magnetic domain control layer 26b for leading magnetic flux from one magnetic domain control layer to another smoothly, and is formed in a plane, which is parallel to a lamination plane that both the magnetic domain control layer 26a and 26b are formed. Specifically, the additional york layer 27 is U-shaped, and has an arm section 27a, an arm section 27b and a parallel section 27c. The arm section 27a and 27b are extend away from ABS, which is a magnetic detection surface of the MR effect multilayered structure. The parallel section 27c is extended to a direction parallel to ABS. One end of the parallel section 27c is connected with the arm section 27a, and opposite end of the parallel section 27c is connected with the arm section 27b. As shown in FIG. 3, the additional york layer 27 is formed in the region, which the lower shield layer 12 and the upper shield layer 15 exist, to connect magnetic domain control layer 26a with 26b by the shortest route.

The soft magnetic material, which magnetic permeability is higher than the one of magnetic material for the lower shield layer 12 and the upper shield layer 15, is preferably used for the additional york layer 27. As an example, material for a magnetic pole such as FeNiCo is used for the additional york layer 27.

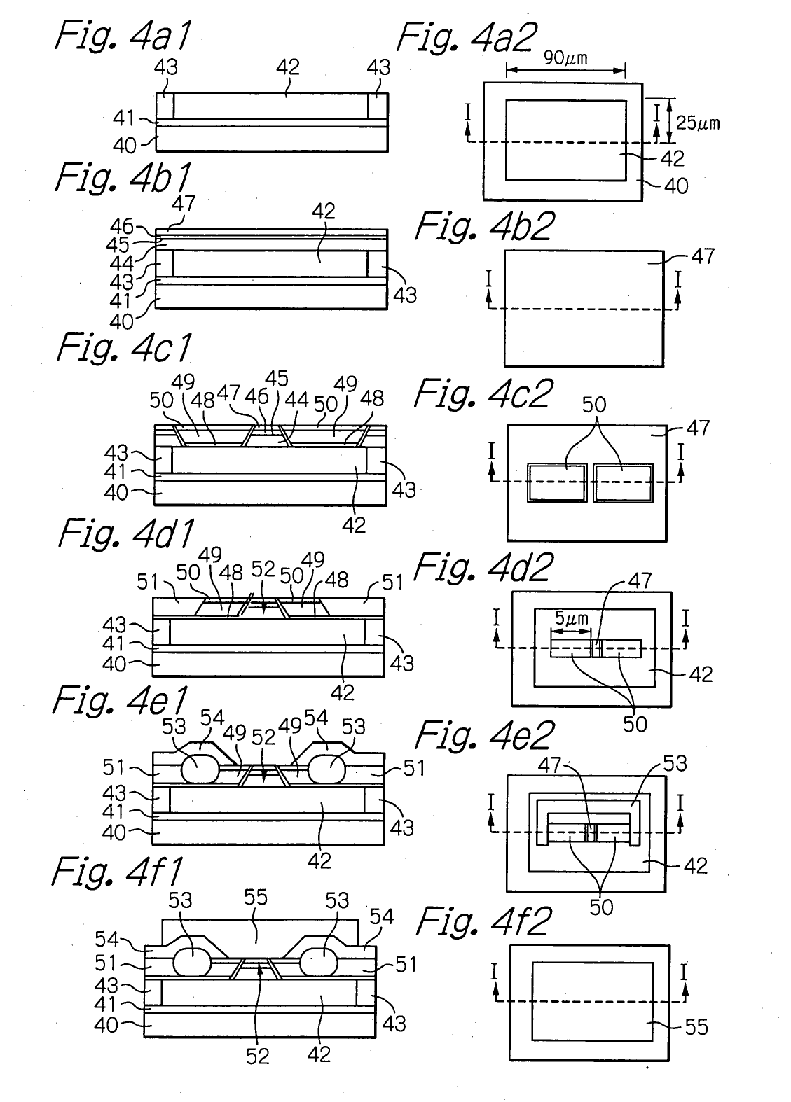

Manufacturing process of the thin film magnetic head, which has the MR effect element according to the embodiment, i.e. TMR effect reading head element, is explained below. FIG. 4a1 to 4f2 show a cross section and plane view for explaining the part of manufacturing process of a TMR effect reading head element. FIGS. 4a1, 4b1, 4c1, 4d1, 4e1 and 4f1 respectively show cross section by the I-I line in FIGS. 4a2, 4b2, 4c2, 4d2, 4e2 and 4f2.

Firstly, an insulation under layer 41, which has a thickness of about 0.05 um to 10 um, is laminated on a substrate 40 using insulating material such as alumina (Al₂O₃) or oxidized silicon (SiO₂) by sputtering method. The substrate 40 is made of electrically conductive material such as AlTic or Al₂O₃—TiC.

Next, a lower shield layer 42, which also acts as a lower electrode layer, is formed on the insulation under layer 41. The lower shield layer 42 is formed by laminating the magnetic metal material, for example FeAlSi, NiFe, CoFe, FeNiCo, FeN, FeZrN, FeTaN, CoZrNb or CoZrTa, by frame plating method, and has a thickness of about 0.1 um to 3 um. After laminating a shield insulating layer 43 on it, the surface is planarized by chemical mechanical polishing (CMP) method. FIGS. 4a1 and 4a2 show this state.

Then a foundation film and a foundation multilayer are formed on the lower shield layer 42 and the shield insulating layer 43 for example by sputtering method. For example, the foundation film is made of tantalum (Ta), hafnium (Hf), niobium (Nb), zirconium (Zr), Ti, molybdenum (Mo) or tungsten (W), and has a thickness of about 0.5 nm to 5 nm. The foundation multilayer is formed by foundation films, which are for example made of NiCr, NiFe, NiFeCr or Ru, and has a thickness of about 1 nm to 5 nm.

Then a magnetization fixed layer 44 is laminated on it. According to the embodiment, the magnetization fixed layer 44 is synthetic type, and formed by layering an antiferromagnetic film (pinning layer), a first ferromagnetic film, a nonmagnetic film and a second ferromagnetic film sequentially by sputtering method. For example, the antiferromagnetic film is formed using IrMN, PtMn, NiMn or RuRhMn, and has a thickness of about 5 nm to 15 nm. For example, the first ferromagnetic film is formed using CoFe, and has a thickness of about 1 nm to 5 nm. For example, the nonmagnetic film is made of alloy which includes ruthenium (Ru), rhodium (Rh), iridium (Ir), chromium (Cr), rhenium (Re) or copper (Cu), and has a thickness of about 0.8 nm. For example, the second ferromagnetic film has two-layered structure formed by sputtering method. A first layer of the second ferromagnetic film is a ferromagnetic film about 1 nm to 3 nm in thickness, and for example formed using CoFeB. A second layer of the second ferromagnetic film is a ferromagnetic film about 0.2 nm to 3 nm in thickness, and for example formed using CoFe.

Then a barrier layer 45, which has a thickness of about 0.3 nm to 1 nm, is laminated on the magnetization fixed layer 44 using aluminum (Al), titanium (Ti), Ta, Zr, Hf, magnesium (Mg), silicon (Si) or zinc (Zn) by sputtering method, and then oxidized.

Then a free layer 46 is formed on the oxidized barrier layer 45 by layering a high polarizability film and a soft magnetic film in series by sputtering method. For example, the high polarizability film has a thickness of about 1 nm, and is formed using CoFe. For example, the soft magnetic film has a thickness of about 2 nm to 6 nm, and is formed using NiFe.

Then a cap layer 47, which includes one or more layers, is formed by sputtering method. For example, the cap layer 47 has a thickness of about 1 nm to 20 nm in thickness, and made of Ta, Ru, Hf, Nb, Zr, Ti, Cr or W. FIGS. 4b1 and 4b2 show this state.

Next, a width, which is the same direction of the track width, of the TMR effect multilayered film is determined, and then a magnetic domain control layer is formed. Firstly, a resist, which has a resist pattern for liftoff, is formed. Then, patterning is performed by ion beam etching for TMR effect multilayered film using the resist as mask. For example Ar ion is used for ion beam etching. And then an insulating layer 48, which has a thickness of about 3 nm to 20 nm, is formed using insulating material such as Al₂O₃ or SiO₂. Then, a foundation layer, a hard bias layer 49, and a bias cap layer 50 are formed in series by sputtering method. For example, the foundation layer is formed using Ta, Ru, Hf, Nb, Zr, Ti, Mo, Cr or W, and the hard bias layer 49 is formed using CoFe, NiFe, COPT or CoCrPT. Finally, the resist is removed in the liftoff process for forming the hard bias layer 49. FIGS. 4c1 and 4c2 show this state.

Next, heights of the TMR effect multilayered film for both track width direction and vertical direction are determined. Firstly, a resist, which has a resist pattern for liftoff, is formed. Then, patterning is performed by ion beam etching for TMR effect multilayered film using the resist as a mask. For example Ar ion is used for ion beam etching. And then an insulating layer 51 is formed using insulating material such as Al₂O₃ or SiO₂ by sputtering method. Finally, the resist is removed in the liftoff process. With each process described above, the TMR effect multilayered structure 52 and the hard bias layer 49 are completed. FIGS. 4d1 and 4d2 show this state.

Each film used for a magnetic sensitive region, which includes the magnetization fixed layer, the barrier layer and the magnetization free layer, is not limited to the one described in this embodiment, and various material and thickness can be applied to each film. For example, instead of three-layered structure which has the first ferromagnetic film, the nonmagnetic film and the second ferromagnetic film, it is possible to use single layer structure, which has a ferromagnetic film, for the magnetization fixed layer. It is also possible to use other layered number for the magnetization fixed layer. Instead of two-layered structure, single layer structure without high polarizability film can be used for the magnetization free layer. It is also possible to use three or more layered structure, which includes a film for magnetostrictive control, for the magnetization free layer. Furthermore, the magnetization fixed layer, the barrier layer and the magnetization free layer can be layered in reverse order, that is the magnetization free layer is the first, the barrier layer is the second, and the magnetization fixed layer is the last. In this case, the antiferromagnetic film in the magnetization fixed layer is placed at the top.

Next, the additional york layer is formed. Firstly, a resist, which has a resist pattern for liftoff, is formed. Then, patterning is performed by ion beam etching for the hard bias layer 49 and the insulating layer 51 using the resist as a mask. For example Ar ion is used for ion beam etching. And then the soft magnetic material, which magnetic permeability is higher than the one of magnetic material for the lower shield layer 42 and the upper shield layer 55, for example FeNiCo, is layered about 100 nm in thickness by sputtering method. Finally, the resist is removed in the liftoff process. With the process described above, the additional york layer 53 is formed. And then an insulation layer 54 is formed using for example sputtering method or ion beam sputtering method. FIGS. 4e1 and 4e2 show this state.

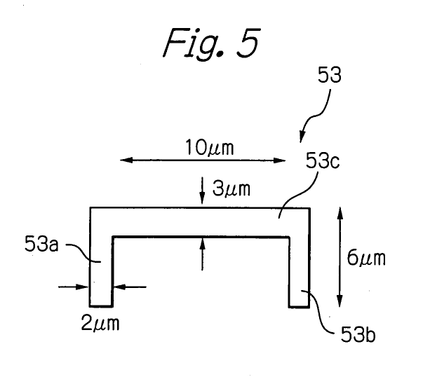

As an example, FIG. 5 shows a dimension for the additional york layer. According to FIG. 5, the planar and U shaped additional york layer has an arm section 53a, an arm section 53b and parallel section 53c. The wide of the arm sections 53a and 53b is about 2 um, and the length of them is about 6 um respectively. The wide of the parallel section 53c is about 3 um, and the length of it is about 10 um. Each end of the parallel section 53c connects the arm sections 53a and 53b respectively. The thickness of the additional york layer 53 is about 100 nm.

Finally, an upper shield layer 55, which has a thickness of about 0.5 um to 3 um, is formed on the insulation layer 54 and the TMR effect multilayered structure using for example frame plating method. Magnetic metal material or multilayered film made of magnetic metal material is used for the upper shield layer 55. Examples of magnetic metal material for the upper shield layer 55 is FeAlSi, NiFe, CoFe, FeNiCo, FeN, FeZrN, FeTaN, CoZrNb or CoZrTa.

The TMR effect reading head element is formed by the process described above.

As described above, according to the embodiment, the additional york layer 27 (53), which is independently formed, leads magnetic flux from one magnetic domain control layer to another magnetic domain control layer. In other words, the additional york layer 27 connects one end of the magnetic domain control layer 26a with one end of the magnetic domain control layer 26b magnetically and continuously. Therefore most magnetic flux from the magnetic domain control layer 26a and 26b enters into the additional york layer 27, and little of it enters into the lower shield layer 12 (42) and the upper shield layer 15 (55).

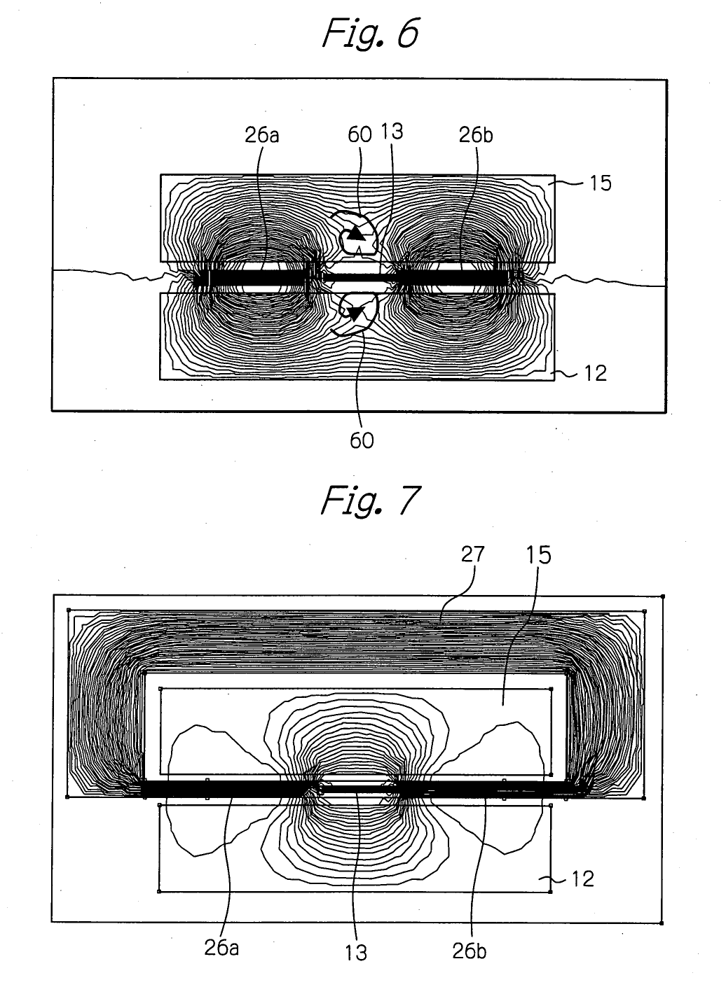

FIG. 6 shows a simulation result of the magnetic flux from the hard bias layer without an additional york layer, and FIG. 7 shows a simulation result of the magnetic flux from the hard bias layer with an additional york layer. These figures show flow of the magnetic flux viewed from the ABS. However, the additional york layer 27 in FIG. 7 is showed on a plane, which is parallel to ABS, because the simulation was performed in 2 dimension.

As shown in FIG. 6, according to the prior art, which has no additional york layer, most magnetic flux from the magnetic domain control layer 26a and 26b enters into the lower shield layer 12 and the upper shield layer 15, and magnetic flux located immediately above the free layer of the MR effect multilayered structure 13 is unstable. Therefore, eddy magnetic field 60 is generated, and shield magnetic domain is unstable. As the result, magnetic disturbance is occurred in the free layer, and it causes the noise. On the other hand, as shown in FIG. 7, most magnetic flux enters into the additional york layer 27, and only a little magnetic flux enters into the lower shield layer 12 and the upper shield layer 15. Furthermore, magnetic flux entering into the lower shield layer 12 and the upper shield layer 15 flows constant at the point located immediately above the free layer, therefore eddy magnetic field is not generated in the shield layer near the free layer. As the result, the magnetic flux from the hard bias layer does not cause the magnetic disturbance of the free layer.

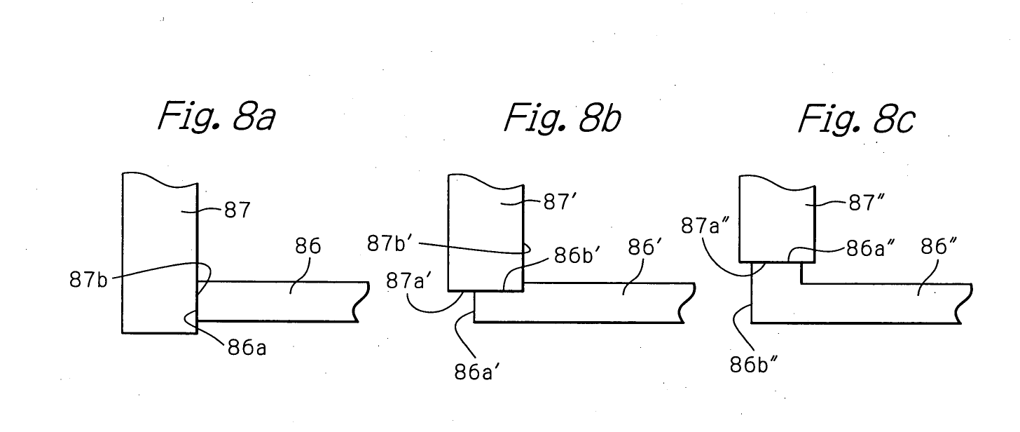

FIG. 8a to 8c show various embodiments of joining of the hard bias layer and the additional york layer.

According to the embodiment, as shown in FIG. 8a, a leading end 86a of a hard bias layer 86 is magnetically connected with a lateral side 87b around a top end area of the additional york layer 87 in such a way that it bumps into the lateral side 87b. In other words, whole surface of the leading end 86a is magnetically contacted with the lateral side 87b. Since magnetic flux from the hard bias layer tends to flow its longitudinal direction, with this configuration, it is possible to lead magnetic flux from the hard bias layer to the additional york layer effectively.

FIG. 8b shows joining example that part of a leading end 86a′ of a hard bias layer 86′ is magnetically contacted with a lateral side 87b′ around a top end area of a additional york layer 87′, and a lateral side 86b′ around the top end area of the hard bias layer 86′ is magnetically contacted with a leading end 87a′ of the additional york layer 87′. With this configuration, magnetic flux from the remaining part of the leading end 86a′, which is not contacted with the additional york layer 87′, leaks outsides.

FIG. 8c shows another joining example that whole surface of a leading end 86a′ of the hard bias layer 86″ is magnetically contacted with a leading end 87a″ of the additional york layer 87″, but a top end area of the hard bias layer 86″ is bended at a right angle. With this configuration, magnetic flux leaks outside from a lateral side 86b″ of the hard bias layer 86′, and does not enter into the additional york layer 87″.

Therefore, configuration as shown in FIG. 8a is the most desirable, one as shown in FIG. 8b is second, and one as shown in FIG. 8C is the least desirable.

A pair of magnetic domain control layers can be formed using an antiferromagnetic layer and a soft ferromagnetic layer, which is exchange-coupled with the antiferromagnetic layer, instead of the hard bias layer.

Furthermore, the additional york layer can be formed in such a way that it spreads outside a region that the upper shield layer and the lower shield layer exit. Also a shape of the additional york layer is not limited to U shaped. Any shape can be used on the condition that it connects a pair of magnetic domain control layers magnetically and continuously.

The invention can be applied to a GMR head, which has a GMR effect reading head element with CIP structure, instead of the TMR head or the GMR head with CPP structure. In this case, the additional york layer needs to be formed using soft magnetic material with electrically insulating characteristic.

Also it is clear that the MR effect element according to the invention can be used for a magnetic sensor instead of the thin film magnetic head.

Many modifications and variations will be apparent those of ordinary skilled in the art. The embodiments was chosen and described in order to best explain the principles of the invention. It should be understood that the present invention is not limited to the specific embodiments described in the specification, except as defined in the appended claims.

1. A magnetoresistive effect element, comprising:
an upper shield layer;
a lower shield layer;
a magnetoresistive effect multilayered structure having a magnetization fixed layer and a magnetization free layer, the magnetoresistive effect multilayered structure being layered between the upper shield layer and the lower shield layer;
a pair of magnetic domain control layers having a first magnetic domain control layer and a second magnetic domain control layer, one end of the first magnetic domain control layer being magnetically coupled with one end of the magnetization free layer, one end of the second magnetic domain control layer being magnetically coupled with another end of the magnetization free layer, and the pair of magnetic domain control layers generating a magnetic flux for controlling magnetic domain of the magnetization free layer; and
an additional york layer, one end of the additional york layer being magnetically coupled with another end of the first magnetic domain control layer, another end of the additional york layer being magnetically coupled with another end of the second magnetic domain control layer, the additional york layer leading magnetic flux from another end of the first magnetic domain control layer to another end of the second magnetic domain control layer.

2. The magnetoresistive effect element according to claim 1, wherein each magnetic domain control layer is made of a hard magnetic layer being extended to a direction parallel to a longitudinal direction of the magnetization free layer.

3. The magnetoresistive effect element according to claim 2, wherein another end of each hard magnetic layer is formed in such a way that it bumps into the additional york layer.

4. The magnetoresistive effect element according to claim 1, wherein each magnetic domain control layer comprises:
an antiferromagnetic layer, and
a soft ferromagnetic layer being exchange-coupled with the antiferromagnetic layer.

5. The magnetoresistive effect element according to claim 1, wherein the additional york layer is formed in a plane parallel to a plane that the pair of magnetic domain control layer is formed.

6. The magnetoresistive effect element according to claim 1, wherein the additional york layer comprises:
two arm sections being extended away from a magnetic detection surface, and
a parallel section being extended parallel to the magnetic detection surface; and
each end of the parallel section is connected with an arm section respectively.

7. The magnetoresistive effect element according to claim 1, wherein the additional york layer is formed in a region that the upper shield layer and the lower shield layer exit.

8. The magnetoresistive effect element according to claim 1, wherein the additional york layer is formed outside a region that the upper shield layer and the lower shield layer exit.

9. The magnetoresistive effect element according to claim 1, wherein the additional york layer is made of a soft magnetic material, magnetic permeability of the soft magnetic material is higher than one of a magnetic material for the upper shield layer and the lower shield layer.

10. The magnetoresistive effect element according to claim 1, wherein the magnetoresistive effect multilayered structure uses sense current perpendicular to a lamination plane.

11. A thin film magnetic head comprising:
the magnetoresistive effect element according to claim 1.
